(19) United States
(12) Patent Application Publication
(10) Pub. No.: US 2006/0004126 A1
(43) Pub. Date: Jan. 5, 2006

(54) Thermoplastic vulcanizate with functional fillers

(76) Inventors: Edward Hosung Park, Saline, MI (US); Francis Joseph Walker, Tecumseh, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(21) Appl. No.: 10/880,682

(22) Filed: Jun. 30, 2004

(51) Int. Cl. C08K 9/06; C08K 3/40; C08K 3/04

(52) U.S. Cl. 523/212; 524/494; 524/495

(57) ABSTRACT

Processable rubber compositions contain a vulcanized fluorocarbon elastomer and functional filler dispersed in a matrix of a thermoplastic polymeric material. In one embodiment the matrix forms a continuous phase and the vulcanized elastomeric material is in the form of particles forming a non-continuous phase. The compositions are made by combining a curative, an uncured fluorocarbon elastomer, a functional filler and a thermoplastic material, and heating the mixture at a temperature and for a time sufficient to effect vulcanization of the elastomeric material, while mechanical energy is applied to mix the mixture during the heating step. Shaped articles such as seals, gaskets, O-rings, and hoses may be readily formed from the rubber compositions according to conventional thermoplastic processes such as blow molding, injection molding, and extrusion.

### BACKGROUND

The present invention relates to thermoplastic vulcanizate. Embodiments include thermoprocessable compositions contain a thermoplastic resin phase and a dispersed amorphous vulcanized elastomer phase, with certain filler materials. It also relates to shaft seal and gasket type material made from the compositions, and methods for their production by dynamic vulcanization techniques.

Cured elastomeric materials have a desirable set of physical properties typical of the elastomeric state. They show a high tendency to return to their original size and shape following removal of a deforming force, and they retain physical properties after repeated cycles of stretching, including strain levels up to 1000%. Based on these properties, the materials are generally useful for making shaped articles such as seals and gaskets.

Because they are thermoset materials, cured elastomeric materials can not generally be processed by conventional thermoplastic techniques such as injection molding, extrusion, or blow molding. Rather, articles must be fashioned from elastomeric materials by high temperature curing and compression molding. Although these and other rubber compounding operations are conventional and known, they nevertheless tend to be more expensive and require higher capital investment than the relatively simpler thermoplastic processing techniques. Another drawback is that scrap generated in the manufacturing process is difficult to recycle and reuse, which further adds to the cost of manufacturing such articles.

In today's automobile engines, the high temperatures of use have led to the development of a new generation of lubricants containing a high level of basic materials such as amines. Articles made from elastomeric materials, such as seals and gaskets, are in contact with such fluids during use, and are subject to a wide variety of challenging environmental conditions, including exposure to high temperature, contact with corrosive chemicals, and high wear conditions during normal use. Accordingly, it is desirable to make such articles from materials that combine elastomeric properties and stability or resistance to the environmental conditions.

Fluorocarbon elastomers have been developed that are highly resistant to the basic compounds found in the lubricating oils and greases. Such elastomers include those based on copolymers of tetrafluoroethylene and propylene. However, as a thermoset material, such cured fluorocarbon elastomers are subject to the processing disadvantages noted above. Thus, it would be desirable to provide an elastomeric or rubber composition that would combine a chemical resistance with the advantages of thermoplastic processability.

### SUMMARY

The present invention provides elastomeric compositions, and methods for making them. Embodiments include compositions comprising a cured fluorocarbon elastomer and functional filler dispersed in a thermoplastic matrix, wherein the cured fluorocarbon elastomer is present as a discrete phase or a phase co-continuous with the matrix. Also provided are composition made by a process comprising dynamically vulcanizing a fluorocarbon elastomer in the presence of a fluorine-containing thermoplastic material and functional filler. Methods include those comprising:
(a) forming a mixture of a fluorocarbon elastomer with a thermoplastic material;
(b) adding a functional filler to the mixture; and
(c) dynamically vulcanizing the mixture.
   In various embodiments, the functional filler is selected from the group consisting of coated carbon fibers, coated glass fibers, high tensile strength aromatic polyamide fibers, and combinations thereof.

Shaped articles may be readily formed from the rubber compositions containing functional fillers according to conventional thermoplastic processes such as blow molding, injection molding, and extrusion. Examples of useful articles include seals, gaskets, O-rings, and hoses.

It has been found that the compositions and methods of this invention afford advantages over compositions and methods among those known in the art. Such advantages include one or more of improved physical characteristics, reduced manufacturing cost, and enhanced recyclability of material. Further benefits and embodiments of the present invention are apparent from the description set forth herein.

### DESCRIPTION

The following definitions and non-limiting guidelines must be considered in reviewing the description of this invention set forth herein.

The headings (such as “Introduction” and “Summary,”) and sub-headings (such as “Elastomeric Material”) used herein are intended only for general organization of topics within the disclosure of the invention, and are not intended to limit the disclosure of the invention or any aspect thereof. In particular, subject matter disclosed in the “Introduction” may include aspects of technology within the scope of the invention, and may not constitute a recitation of prior art. Subject matter disclosed in the “Summary” is not an exhaustive or complete disclosure of the entire scope of the invention or any embodiments thereof.

The citation of references herein does not constitute an admission that those references are prior art or have any relevance to the patentability of the invention disclosed herein. All references cited in the Description section of this specification are hereby incorporated by reference in their entirety.

The description and specific examples, while indicating embodiments of the invention, are intended for purposes of illustration only and are not intended to limit the scope of the invention. Moreover, recitation of multiple embodiments having stated features is not intended to exclude other embodiments having additional features, or other embodiments incorporating different combinations of the stated features. Specific Examples are provided for illustrative purposes of how to make, use and practice the compositions and methods of this invention and, unless explicitly stated otherwise, are not intended to be a representation that given embodiments of this invention have, or have not, been made or tested.

As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the word “include,” and its variants, is intended to be non-limiting, such that recitation of items in a list is not to the exclusion of other like items that may also be useful in the materials, compositions, devices, and methods of this invention.

Processable rubber compositions are provided that contain a vulcanized elastomeric material and functional filler dispersed in a thermoplastic matrix. The vulcanized elastomeric material is the product of vulcanizing, crosslinking, or curing a fluorocarbon elastomer. The processable rubber compositions may be processed by conventional thermoplastic techniques to form shaped articles having physical properties that make them useful in a number of applications calling for elastomeric properties.

Elastomeric Material:

Preferred fluorocarbon elastomers include commercially available copolymers of one or more fluorine containing monomers, chiefly vinylidene fluoride (VDF), hexafluoropropylene (HFP), tetrafluoroethylene (TFE), and perfluorovinyl ethers (PFVE). Preferred PFVE include those with a C₁₋₈ perfluoroalkyl group, preferably perfluoroalkyl groups with 1 to 6 carbons, and particularly perfluoromethyl vinyl ether and perfluoropropyl vinyl ether. In addition, the copolymers may also contain repeating units derived from olefins such as ethylene (Et) and propylene (Pr). The copolymers may also contain relatively minor amounts of cure site monomers (CSM), discussed further below. Preferred copolymer fluorocarbon elastomers include VDF/HFP, VDF/HFP/CSM, VDF/HFP/TFE, VDF/HFP/TFE/CSM, VDF/PFVE/TFE/CSM, TFE/Pr, TFE/Pr/VDF, TFE/Et/PFVE/VDF/CSM, TFE/Et/PFVE/CSM and TFE/PFVE/CSM. The elastomer designation gives the monomers from which the elastomer gums are synthesized. The elastomer gums have viscosities that give a Mooney viscosity in the range generally of 15-160 (ML1+10, large rotor at 121° C.), which can be selected for a combination of flow and physical properties. Elastomer suppliers include Dyneon (3M), Asahi Glass Fluoropolymers, Solvay/Ausimont, Dupont, and Daikin.

Thermoplastic Matrix:

In one embodiment, the thermoplastic material making up the matrix includes at least one component that is a non-fluorine containing thermoplastic polymer. In another embodiment, the thermoplastic material includes a fluorine-containing thermoplastic material. The polymeric material softens and flows upon heating. In one aspect, a thermoplastic material is one the melt viscosity of which can be measured, such as by ASTM D-1238 or D-2116, at a temperature above its melting point.

The thermoplastic material of the invention may be selected to provide enhanced properties of the rubber/thermoplastic combination at elevated temperatures, preferably above 100° C. and more preferably at about 150° C. and higher. Such thermoplastics include those that maintain physical properties, such as at least one of tensile strength, modulus, and elongation at break to an acceptable degree at the elevated temperature. In a preferred embodiment, the thermoplastics possess physical properties at the elevated temperatures that are superior (i.e. higher tensile strength, higher modulus, and/or higher elongation at break) to those of the cured fluorocarbon elastomer (rubber) at a comparable temperature.

The thermoplastic polymeric material used in the invention may be a thermoplastic elastomer. Thermoplastic elastomers have some physical properties of rubber, such as softness, flexibility and resilience, but may be processed like thermoplastics. A transition from a melt to a solid rubber-like composition occurs fairly rapidly upon cooling. This is in contrast to conventional elastomers, which harden slowly upon heating. Thermoplastic elastomers may be processed on conventional plastic equipment such as injection molders and extruders. Scrap may generally be readily recycled.

Thermoplastic elastomers have a multi-phase structure, wherein the phases are generally intimately mixed. In many cases, the phases are held together by graft or block copolymerization. At least one phase is made of a material that is hard at room temperature but fluid upon heating. Another phase is a softer material that is rubber like at room temperature.

Some thermoplastic elastomers have an A-B-A block copolymer structure, where A represents hard segments and B is a soft segment. Because most polymeric material tend to be incompatible with one another, the hard and soft segments of thermoplastic elastomers tend to associate with one another to form hard and soft phases. For example, the hard segments tend to form spherical regions or domains dispersed in a continuous elastomer phase. At room temperature, the domains are hard and act as physical crosslinks tying together elastomeric chains in a 3-D network. The domains tend to lose strength when the material is heated or dissolved in a solvent.

Other thermoplastic elastomers have a repeating structure represented by (A-B)ₙ, where A represents the hard segments and B the soft segments as described above.

Many thermoplastic elastomers are known. Non-limiting examples of A-B-A type thermoplastic elastomers include polystyrene/polysiloxane/polystyrene, polystyrene/polyethylene-co-butylene/polystyrene, polystyrene/polybutadiene polystyrene, polystyrene/polyisoprene/polystyrene, poly-α-methyl styrene/polybutadiene/poly-α-methyl styrene, poly-α-methyl styrene/polyisoprene/poly-α-methyl styrene, and polyethylene/polyethylene-co-butylene/polyethylene.

Non-limiting examples of thermoplastic elastomers having a (A-B)ₙ repeating structure include polyamide/polyether, polysulfone/polydimethylsiloxane, polyurethane/polyester, polyurethane/polyether, polyester/polyether, polycarbonate/polydimethylsiloxane, and polycarbonate/polyether. Among the most common commercially available thermoplastic elastomers are those that contain polystyrene as the hard segment. Triblock elastomers are available with polystyrene as the hard segment and either polybutadiene, polyisoprene, or polyethylene-co-butylene as the soft segment. Similarly, styrene butadiene repeating co-polymers are commercially available, as well as polystyrene/polyisoprene repeating polymers.

In a preferred embodiment, a thermoplastic elastomer is used that has alternating blocks of polyamide and polyether. Such materials are commercially available, for example from Atofina under the Pebax® trade name. The polyamide blocks may be derived from a copolymer of a diacid component and a diamine component, or may be prepared by homopolymerization of a cyclic lactam. The polyether block is generally derived from homo- or copolymers of cyclic ethers such as ethylene oxide, propylene oxide, and tetrahydrofuran.

The thermoplastic polymeric material may also be selected from among solid, generally high molecular weight, plastic materials. Preferably, the materials are crystalline or semi-crystalline polymers, and more preferably have a crystallinity of at least 25 percent as measured by differential scanning calorimetry. Amorphous polymers with a suitably high glass transition temperature are also acceptable as the thermoplastic polymeric material. The thermoplastic also preferably has a melt temperature or glass transition temperature in the range from about 80° C. to about 350° C., but the melt temperature should generally be lower than the decomposition temperature of the thermoplastic vulcanizate.

Non-limiting examples of thermoplastic polymers include polyolefins, polyesters, nylons, polycarbonates, styrene-acrylonitrile copolymers, polyethylene terephthalate, polybutylene terephthalate, polyamides, polystyrene, polystyrene derivatives, polyphenylene oxide, polyoxymethylene, and fluorine-containing thermoplastics.

Polyolefins are formed by polymerizing α-olefins such as, but not limited to, ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another α-olefin such as 1-butene, 1-hexene, 1-octene, 2-methyl-1-propene, 3-methyl-1-pentene, 4methyl-1-pentene, 5-methyl-1-hexene or mixtures thereof are also contemplated. These homopolymers and copolymers, and blends of them, may be incorporated as the thermoplastic polymeric material of the invention.

Polyester thermoplastics contain repeating ester linking units in the polymer backbone. In one embodiment, they contain repeating units derived from low molecular weight diols and low molecular weight aromatic diacids. Non-limiting examples include the commercially available grades of polyethylene terephthalate and polybutylene terephthalate. Alternatively, the polyesters may be based on aliphatic diols and aliphatic diacids. Exemplary here the copolymers of ethylene glycol or butanediol with adipic acid. In another embodiment, the thermoplastic polyesters are polylactones, prepared by polymerizing a monomer containing both hydroxyl and carboxyl functionality. Polycaprolactone is a non-limiting example of this class of thermoplastic polyester.

Polyamide thermoplastics contain repeating amide linkages in the polymer backbone. In one embodiment, the polyamides contain repeating units derived from diamine and diacid monomers such as the well known nylon 66, a polymer of hexamethylene diamine and adipic acid. Other nylons have structures resulting from varying the size of the diamine and diacid components. Non-limiting examples include nylon 610, nylon 612, nylon 46, and nylon 6/66 copolymer. In another embodiment, the polyamides have a structure resulting from polymerizing a monomer with both amine and carboxyl functionality. Non-limiting examples include nylon 6 (polycaprolactam), nylon 11, and nylon 12.

Other polyamides made from diamine and diacid components include the high temperature aromatic polyamides containing repeating units derived from diamines and aromatic diacids such as terephthalic acid. Commercially available examples of these include PA6T (a copolymer of hexanediamine and terephthalic acid), and PA9T (a copolymer of nonanediamine and terephthalic acid), sold by Kuraray under the Genestar tradename. For some applications, the melting point of some aromatic polyamides may be higher than optimum for thermoplastic processing. In such cases, the melting point may be lowered by preparing appropriate copolymers. In a non-limiting example, in the case of PA6T, which has a melting temperature of about 370° C., it is possible to in effect lower the melting point to below a moldable temperature of 320° C. by including an effective amount of a non-aromatic diacid such as adipic acid when making the polymer.

In another preferred embodiment, an aromatic polyamide is used based on a copolymer of an aromatic diacid such as terephthalic acid and a diamine containing greater than 6 carbon atoms, preferably containing 9 carbon atoms or more. The upper limit of the length of the carbon chain of the diamine is limited from a practical standpoint by the availability of suitable monomers for the polymer synthesis. As a rule, suitable diamines include those having from 7 to 20 carbon atoms, preferably in the range of 9 to 15 carbons, and more preferably in the range from 9 to 12 carbons. Preferred embodiments include C9, C10, and C11 diamine based aromatic polyamides. It is believed that such aromatic polyamides exhibit an increase level of solvent resistance based on the oleophilic nature of the carbon chain having greater than 6 carbons. If desired to reduce the melting point below a preferred molding temperature (typically 320° C. or lower), the aromatic polyamide based on diamines of greater than 6 carbons may contain an effective amount of a non-aromatic diacid, as discussed above with the aromatic polyamide based on a 6 carbon diamine. Such effective amount of diacid should be enough to lower the melting point into a desired molding temperature range, without unacceptably affecting the desired solvent resistance properties.

Other non-limiting examples of high temperature thermoplastics include polyphenylene sulfide, liquid crystal polymers, and high temperature polyimides. Liquid crystal polymers are based chemically on linear polymers containing repeating linear aromatic rings. Because of the aromatic structure, the materials form domains in the nematic melt state with a characteristic spacing detectable by x-ray diffraction methods. Examples of materials include copolymers of hydroxybenzoic acid, or copolymers of ethylene glycol and linear aromatic diesters such as terephthalic acid or naphthalene dicarboxylic acid.

High temperature thermoplastic polyimides include the polymeric reaction products of aromatic dianhydrides and aromatic diamines. They are commercially available from a number of sources. Exemplary is a copolymer of 1,4-benzenediamine and 1,2,4,5-benzenetetracarboxylic acid dianhydride.

In one embodiment, the matrix comprises at least one non-fluorine containing thermoplastic, such as those described above. Thermoplastic fluorine-containing polymers may be selected from a wide range of polymers and commercial products. The polymers are melt processable—they soften and flow when heated, and can be readily processed in thermoplastic techniques such as injection molding, extrusion, compression molding, and blow molding. The materials are readily recyclable by melting and re-processing.

The thermoplastic polymers may be fully fluorinated or partially fluorinated. Fully fluorinated thermoplastic polymers include copolymers of tetrafluoroethylene and perfluoroalkyl vinyl ethers. The perfluoroalkyl group is preferably of 1 to 6 carbon atoms. Other examples of copolymers are PFA (copolymer of TFE and perfluoropropyl vinyl ether) and MFA (copolymer of TFE and perfluoromethyl vinyl ether). Other examples of fully fluorinated thermoplastic polymers include copolymers of TFE with perfluoroolefins of 3 to 8 carbon atoms. Non-limiting examples include FEP (copolymer of TFE and hexafluoropropylene).

Partially fluorinated thermoplastic polymers include E-TFE (copolymer of ethylene and TFE), E-CTFE (copolymer of ethylene and chlorotrifluoroethylene), and PVDF (polyvinylidene fluoride). A number of thermoplastic copolymers of vinylidene fluoride are also suitable thermoplastic polymers for use in the invention. These include, without limitation, copolymers with perfluoroolefins such as hexafluoropropylene, and copolymers with chlorotrifluoroethylene.

Thermoplastic terpolymers may also be used. These include thermoplastic terpolymers of TFE, HFP, and vinylidene fluoride.

These and other fluorine-containing thermoplastic materials are commercially available. Suppliers include Dyneon (3M), Daikin, Asahi Glass Fluoroplastics, Solvay/Ausimont and DuPont.

Functional Filler:

The compositions of the present invention comprise a functional filler. As referred to herein, a “functional filler” is a material which is operable in a composition of the invention improve one or more properties of the composition. Such properties include one or more chemical or physical properties relating to the formulation, function or utility of the composition, such as physical characteristics, performance characteristics, applicability to specific end-use devices or environments, ease of manufacturing the composition, and ease of processing the composition after its manufacture. Functional fillers useful herein include those selected from the group consisting of reinforcing fillers, lubricating fillers, thermal conductive fillers, electrical conductive fillers, physical extender fillers, and mixtures thereof. Fillers include both organic and inorganic fillers such as, barium sulfate, zinc sulfide, carbon black, silica, titanium dioxide, clay, talc, fiber glass, fumed silica and discontinuous fibers such as mineral fibers, wood cellulose fibers, carbon fiber, boron fiber, and aramid fiber, and mixtures thereof. Some non-limiting examples of processing additives added with the filler include stearic acid and lauric acid. In various embodiments, the compositions comprise from about 0.1 to about 50% by weight of the composition. Optionally, the compositions comprise from about 1 to about 40%, or from about 10 to 30% of the filler.

Reinforcing fillers improve physical properties such as overall strength, hardness, abrasion resistance, compression set, tensile strength, tensile modulus and elongation at break. The reinforcing fillers can be either in fiber or powder form. As used herein, powder form is defined as a solid dry functional filler material of small particle size, in some embodiments ranging down to colloidal dimensions, and includes granules, flakes, dust, and mixtures thereof. The functional fillers may be transformed into powder form in any manner known in the art. Non-limiting examples include comminuting larger units via mechanical grinding, by combustion (carbon black), and by precipitation via a chemical reaction.

Some non-limiting examples of reinforcing fiber fillers include fumed silica, natural or synthetic fibers, glass fibers, carbon fibers, boron fibers, polyester, acrylic, colored pigments, polyimide, polyamide, and aramid fibers. Preferred reinforcing fibers include glass fibers, carbon fiber, and high tensile strength aromatic polyamide fibers. One embodiment of a polyamide fiber useful herein is commercially available as Kevlar®, marketed by E.I. du Pont de Nemours and Company. Kevlar® is a polyamide in which all of the amide groups are separated by para-phenylene groups, that is, the amide groups attach to the phenol rings opposite to each other, at carbons 1 and 4.

Some non-limiting examples of reinforcing powder fillers may include carbon black powder, glass bead, polyimide powder, MoS₂ powder, steel powder, brass powder, and aluminum powder. In one embodiment, the addition of carbon black, along with extender oil, preferably prior to dynamic vulcanization, is particularly preferred. Non-limiting examples of carbon black fillers include SAF black, HAF black, SRP black and Austin black. Carbon black improves the tensile strength, and an extender oil can improve processability, the resistance to oil swell, heat stability, hysteresis, cost, and permanent set.

The addition of lubricating fillers improves the abrasion and wear characteristics of the fluorocarbon elastomers. Lubricating fillers, as used herein, include materials having characteristic crystalline habit, which may cause the filler material to shear into thin, flat plates operable to readily slide over one another, thus having an antifriction or lubricating effect. Some non-limiting examples of lubricating fillers include PTFE powder, silicon powder, and graphite powder. The lubricating fillers include solid and synthetic lubricants.

The addition of conductive fillers enhances the thermal and electrical conductivity properties of the fluorocarbon elastomers. Conductive fillers, as used herein, include materials operable to enable the transfer or heat or electric current from one substance to another when the two substances are in contact with one another. Crystalline solids are good thermal and electrical conductors, especially metals and alloys. Non-limiting examples of conductive fillers include carbon fiber or powder, aluminum powder, brass powder, steel powder, and other conductive metals.

The addition of a simple physical extender fillers stabilizes the fluorocarbon elastomer compound and improves the dispersion of elastomers and plastic phases. Extender fillers, as used herein, include inert, low-gravity materials that can be added to the compound to increase bulk and reduce cost per unit volume. Some non-limiting examples include kaolin (clay), mica and talc powder.

In various embodiments, certain reinforcing fillers, such as glass fiber, carbon fiber, Kevlar® fiber, boron fiber, PTFE fiber and other ceramic fibers, may exhibit compatibility issues with elastomers, plastics, and elastomer/plastic compounds, including thermoplastic vulcanizate compositions containing cured fluorocarbon elastomers. Poor adherence to the matrix may yield undesirable physical properties. The modification and coating of a certain filler surfaces improves the effectiveness of the filler by enhancing the affinity among the fillers, elastomers and plastics.

The surface treatment of fillers by chemical or physical means helps to improve interfacial bonding to the matrix. In preferred embodiments, certain fillers such as aramid fibers, carbon fibers, or glass fibers, are etched, chemically treated, or have a coating applied to improve the compatibility with the matrix. This bonding enhancement technology results in more homogeneous compounds. Specialized coatings on fiber fillers improves the bonding wherein fillers migrate to the surface and contact metal or plastic thereby triggering bonding.

In one embodiment, the functional filler surface is subjected to plasma treatment to improve bonding to the elastomer/plastic matrix. Plasma treatments useful herein include treatments known in the art, wherein plasma interacts with the surface of the filler in a variety of ways. As used herein, plasma denotes a more or less ionized gas, a gaseous complex which may be composed of electrons, ions of either polarity, gaseous atoms and molecules in the ground or any higher state of any form of excitation. Low temperature plasmas contain high energy electrons and low energy species such as atoms, ions, and radicals. The electrons are able to cleave covalent bonds and induce subsequent reactions with the other plasma particles. Furthermore, ions, atoms and radicals are also able to interact with the surface to be treated. Depending on the plasma gas used, the surface characteristics of fibers can be specifically modified for example by etching, plasma induced grafting, and/or plasma polymerization. Application of electromagnetic energy, such as microwaves, is an example of a low temperature plasma treatment. In addition to removing moisture and possibly other contaminates, plasma treatment also acts to increase the number of nucleation sites through the introduction of polar groups. This results in a coating with homogeneous surface morphology and less defects. In one embodiment, Kevlar® fiber filler, or a functionally equivalent high tensile strength aromatic aramid fiber, is pretreated with plasma to enhance adhesion in the bonding enhancement of the fiber filler to the elastomer/plastic matrix.

One embodiment of the present invention uses chemically treated or coated reinforced fillers for bonding enhancement and to improve adhesion of fillers in a matrix. Application of silane or maleic anhydride based bonding agents to the surface of the functional filler is one non-limiting example of this chemical approach used to enhance compatibility with the elastomer/plastic matrix. Preferred embodiments include the use of epoxy silane coated calcium silicate (Nyad 10222) and glass fiber. Another embodiment includes the use of silane coated Kevlar® fiber, or a functionally equivalent high tensile strength aromatic aramid fiber, for bonding enhancement.

Curative Agent:

In various embodiments, the compositions of the present invention comprise a curative agent, to effect curing of the composition. Useful curative agents include diamines, peroxides, and polyol/onium salt combinations. Diamine curatives have been known since the 1950's. Diamine curatives are relatively slow curing, but offer advantages in several areas. Such curatives are commercially available, for example as Diak-1 from DuPont Dow Elastomers.

Preferred peroxide curative agents are organic peroxides, preferably dialkyl peroxides. In general, an organic peroxide may be selected to function as a curing agent for the composition in the presence of the other ingredients and under the temperatures to be used in the curing operation without causing any harmful amount of curing during mixing or other operations which are to precede the curing operation. A dialkyl peroxide which decomposes at a temperature above 49° C. is especially preferred when the composition is to be subjected to processing at elevated temperatures before it is cured. In many cases one will prefer to use a di-tertiarybutyl peroxide having a tertiary carbon atom attached to a peroxy oxygen. Non-limiting examples include 2,5-dimethyl-2,5-di(tert-butylperoxy)-3-hexyne; 2,5-dimethyl-2,5-di(tert-butylperoxy) hexane; and 1,3-bis-(t-butylperoxyisopropyl)benzene. Other non-limiting examples of peroxide curative agents include dicurnyl peroxide, dibenzoyl peroxide, tertiary butyl perbenzoate, di[1,3-dimethyl-3-(t-butylperoxy)butyl]carbonate, and the like.

One or more crosslinking co-agents may be combined with the peroxide. Examples include triallyl cyanurate; triallyl isocyanurate; tri(methallyl)-isocyanurate; tris(diallylamine)-s-triazine, triallyl phosphite; N,N-diallyl acrylamide; hexaallyl phosphoramide; N,N,N′,N′-tetraallyl terephthalamide; N,N,N′,N′-tetraallyl malonamide; trivinyl isocyanurate; 2,4,6-trivinyl methyltrisiloxane; and tri(5-norbornene-2-methylene) cyanurate.

Suitable onium salts are described, for example, in U.S. Pat. Nos. 4,233,421; 4,912,171; and 5,262,490, each of which is incorporated by reference. Examples include triphenylbenzyl phosphonium chloride, tributyl alkyl phosphonium chloride, tributyl benzyl ammonium chloride, tetrabutyl ammonium bromide, and triarylsulfonium chloride.

Another class of useful onium salts is represented by the following formula: 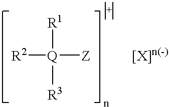
where
Q is nitrogen or phosphorus;
Z is a hydrogen atom or
   is a substituted or unsubstituted, cyclic or acyclic alkyl group having from 4 to about 20 carbon atoms that is terminated with a group of the formula —COOA where A is a hydrogen atom or a NH₄⁺ cation or Z is a group of the formula —CY₂ COOR′ where Y is a hydrogen or halogen atom, or is a substituted or unsubstituted alkyl or aryl group having from 1 to about 6 carbon atoms that may optionally contain one or more quaternary heteroatoms and where R′ is a hydrogen atom, a NH₄⁺ cation, an alkyl group, or is an acyclic anhydride, e.g., a group of the formula —COR where R is an alkyl group or is a group that itself contains organo-onium (i.e., giving a bis-organo-onium); preferably R′ is hydrogen; Z may also be a substituted or unsubstituted, cyclic or acyclic alkyl group having from 4 to about 20 carbon atoms that is terminated with a group of the formula —COOA where A is a hydrogen atom or is a NH₄⁺ cation;
R₁, R₂, and R₃ are each, independently, a hydrogen atom or an alkyl, aryl, alkenyl, or any combination thereof, each R₁, R₂, and R₃ can be substituted with chlorine, fluorine, bromine, cyano, —OR″, or —COOR″ where R″ is a C₁ to C₂₀ alkyl, aryl, aralkyl, or alkenyl, and any pair of the R₁, R₂, and R₃ groups can be connected with each other and with Q to form a heterocyclic ring; one or more of the R₁, R₂, and R₃ groups may also be a group of the formula Z where Z is as defined above;
X is an organic or inorganic anion (for example, without limitation, halide, sulfate, acetate, phosphate, phosphonate, hydroxide, alkoxide, phenoxide, or bisphenoxide); and
n is a number equal to the valence of the anion X.

The polyol crosslinking agents may be any of those polyhydroxy compounds known in the art to function as a crosslinking agent or co-curative for fluoroelastomers, such as those polyhydroxy compounds disclosed in U.S. Pat. No. 4,259,463 (Moggi et al.), U.S. Pat. No. 3,876,654 (Pattison), U.S. Pat. No. 4,233,421 (Worm), and U.S. Defensive Publication T107,801 (Nersasian). Preferred polyols include aromatic polyhydroxy compounds, aliphatic polyhydroxy compounds, and phenol resins.

Representative aromatic polyhydroxy compounds include any one of the following: di-, tri-, and tetrahydroxybenzenes, -naphthalenes, and -anthracenes, and bisphenols of the Formula 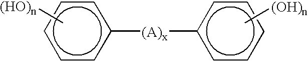
wherein A is a difunctional aliphatic, cycloaliphatic, or aromatic radical of 1 to 13 carbon atoms, or a thio, oxy, carbonyl, or sulfonyl radical, A is optionally substituted with at least one chlorine or fluorine atom, x is 0 or 1, n is 1 or 2, and any aromatic ring of the polyhydroxy compound is optionally substituted with at least one atom of chlorine, fluorine, or bromine atom, or carboxyl or an acyl radical (e.g., —COR, where R is H or a C₁ to C₈ alkyl, aryl or cycloalkyl group) or alkyl radical with, for example, 1 to 8 carbon atoms. It will be understood from the above bisphenol formula III that the —OH groups can be attached in any position (other than number one) in either ring. Blends of two or more such compounds can also be used. A preferred bisphenol compound is Bisphenol AF, which is 2,2-bis(4-hydroxyphenyl)hexafluoropropane. Other non-limiting examples include 4,4′-dihydroxydiphenyl sulfone (Bisphenol S) and 2,2-bis(4-hydroxyphenyl) propane (Bisphenol A). Aromatic polyhydroxy compound, such as hydroquinone may also be used as curative agents. Further non-limiting examples include catechol, resorcinol, 2-methyl resorcinol, 5-methyl resorcinol, 2-methyl hydroquinone, 2,5-dimethyl hydroquinone, and 2-t-butyl hydroquinone, 1,5-dihydroxynaphthalene and 9,10-dihydroxyanthracene.

Aliphatic polyhydroxy compounds may also be used as a polyol curative. Examples include fluoroaliphatic diols, e.g. 1,1,6,6-tetrahydrooctafluorohexanediol, and others such as those described in U.S. Pat. No. 4,358,559 (Holcomb et al.) and references cited therein. Derivatives of polyhydroxy compounds can also be used such as those described in U.S. Pat. No. 4,446,270 (Guenthner et al.) and include, for example, 2-(4-allyloxyphenyl)-2-(4-hydroxyphenyl)propane. Mixtures of two or more of the polyhydroxy compounds can be used.

Phenol resins capable of crosslinking a rubber polymer can be employed as the polyol curative agent. Reference to phenol resin may include mixtures of these resins. U.S. Pat. Nos. 2,972,600 and 3,287,440 are incorporated herein in this regard. These phenolic resins can be used to obtain the desired level of cure without the use of other curatives or curing agents.

Phenol resin curatives can be made by the condensation of alkyl substituted phenols or unsubstituted phenols with aldehydes, preferably formaldehydes, in an alkaline medium or by condensation of bi-functional phenoldialcohols. The alkyl substituents of the alkyl substituted phenols typically contain 1 to about 10 carbon atoms. Dimethylolphenols or phenolic resins, substituted in para-positions with alkyl groups containing 1 to about 10 carbon atoms, are preferred. Useful commercially available phenol resins include alkylphenol-formaldehyde resin, and bromomethylated alkylphenol-formaldehyde resins.

In one embodiment, phenol resin curative agents may be represented by the general formula 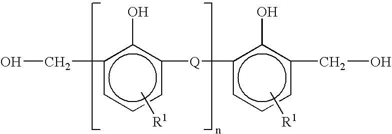
where Q is a divalent radical selected from the group consisting of —CH₂— and —CH₂—O—CH₂—; m is zero or a positive integer from 1 to 20 and R′ is hydrogen or an organic radical. Preferably, Q is the divalent radical —CH₂—O—CH₂—, m is zero or a positive integer from 1 to 10, and R′ is hydrogen or an organic radical having less than 20 carbon atoms. In another embodiment, preferably m is zero or a positive integer from 1 to 5 and R′ is an organic radical having between 4 and 12 carbon atoms. Other preferred phenol resins are also defined in U.S. Pat. No. 5,952,425, which is incorporated herein by reference.
Optional Materials:

In various embodiments, plasticizers, extender oils, synthetic processing oils, or a combination thereof are used in the compositions of the invention. The type of processing oil selected will typically be consistent with that ordinarily used in conjunction with the specific rubber or rubbers present in the composition. The extender oils may include, but are not limited to, aromatic, naphthenic, and paraffinic extender oils. Preferred synthetic processing oils include polylinear α-olefins. The extender oils may also include organic esters, alkyl ethers, or combinations thereof. As disclosed in U.S. Pat. No. 5,397,832, it has been found that the addition of certain low to medium molecular weight organic esters and alkyl ether esters to the compositions of the invention lowers the Tg of the thermoplastic and rubber components, and of the overall composition, and improves the low temperatures properties, particularly flexibility and strength. These organic esters and alkyl ether esters generally have a molecular weight that is generally less than about 10,000. Particularly suitable esters include monomeric and oligomeric materials having an average molecular weight below about 2000, and preferably below about 600. In one embodiment, the esters may be either aliphatic mono- or diesters or alternatively oligomeric aliphatic esters or alkyl ether esters.

In addition to the elastomeric material, the thermoplastic polymeric material, functional filler and curative, the processable rubber compositions of this invention may include other additives such as stabilizers, processing aids, curing accelerators, pigments, adhesives, tackifiers, waxes, and mixtures thereof. These additives may be added to the composition at various times, and may also be pre-mixed as a curative package. As used herein, a curative package may include any combination of additives as known in the art, or could simply only contain curing agent. The properties of the compositions and articles of the invention may be modified, either before or after vulcanization, by the addition of ingredients that are conventional in the compounding of rubber, thermoplastics, and blends thereof.

A wide variety of processing aids may be used, including plasticizers and mold release agents. Non-limiting examples of processing aids include Caranuba wax, phthalate ester plasticizers such as dioctylphthalate (DOP) and dibutylphthalate silicate (DBS), fatty acid salts such zinc stearate and sodium stearate, polyethylene wax, and keramide. In some embodiments, high temperature processing aids are preferred. Such include, without limitation, linear fatty alcohols such as blends of C₁₀-C₂₈ alcohols, organosilicones, and functionalized perfluoropolyethers. In some embodiments, the compositions contain about 1 to about 15% by weight processing aids, preferably about 5 to about 10% by weight.

Acid acceptor compounds are commonly used as curing accelerators or curing stabilizers. Preferred acid acceptor compounds include oxides and hydroxides of divalent metals. Non-limiting examples include Ca(OH)₂, MgO, CaO, and ZnO.

In preferred embodiments, the compositions contain 35% by weight or more, and preferably 40% by weight or more of the elastomer phase, based on the total weight of elastomer and thermoplastic material. In other embodiments, the compositions contain 50% by weight or more of the elastomer phase. In preferred embodiments, the compositions further contain 5% to 50% by weight functional filler material, preferably 20% to 30% by weight, based on the total weight of the vulcanized elastomeric material, thermoplastic material and functional filler material combined.

The compositions are homogenous blends of two phases that are sufficiently compatible that the compositions may readily be formed into shaped articles having sufficient elastomer properties, such as tensile strength, modulus, elongation at break, and compression set to be industrially useful as seals, gaskets, O-rings, hoses, and the like. In one aspect, the rubber compositions are made of two-phases where the matrix forms a continuous phase, the vulcanized elastomeric material is in the form of particles forming a non-continuous, disperse, or discrete phase, and the functional filler is dispersed in the matrix. In another aspect, the elastomeric material, functional filler and the matrix form co-continuous phases.

The elastomer phase may be present in the form of particles in a continuous thermoplastic phase, as a 3-D network forming a co-continuous phase with the thermoplastic material, or as a mixture of both. The particles or 3-D network of the elastomer phase preferably have minimum dimensions of 10 μm or less, and more preferably 1 μm or less. Similarly, the functional filler may be present in a fiber form in a continuous thermoplastic phase, as a 3-D network forming a co-continuous phase with the thermoplastic material, or as a mixture of both. Preferably, the average fiber diameter is between about 0.01 to 1,000 μm, more preferably, between about 0.1 to 100 μm. The fibers preferably have an aspect ratio length of about 1:1,000, more preferably about 5:50.

As previously discussed, the functional filler may also be present in a powder form. Likewise, the powder form functional filler may be present in the form of particles in a continuous thermoplastic phase, as a 3-D network forming a co-continuous phase with the thermoplastic material, or as a mixture of both. The powder form functional filler particles preferably have a particle size of between about 0.01 to 1,000 μm, more preferably, between about 0.1 to 100 μm.

In particular embodiments, shaped articles made from the processable compositions typically exhibit a Shore A hardness of 50 or more, preferably Shore A 70 or more, typically in the range of Shore A 70 to Shore A 90. In addition or alternatively, the tensile strength of the shaped articles will preferably be 4 MPa or greater, preferably 8 MPa or greater, typically about 8-13 MPa. In still other embodiments, shaped articles may be characterized as having a modulus at 100% of at least 2 MPa, preferably at least about 4 MPa, and typically in the range of about 4-8 MPa. In other embodiments, elongation at break of articles made from the processable compositions of the invention will be 10% or greater, preferably at least about 50%, more preferably at least about 150%, and typically in the range of 150-300%. Shaped articles of the invention may be characterized as having at least one of hardness, tensile strength, modulus, and elongation at break in the above noted ranges.

Methods of Manufacture:

The rubber composition of the invention may be made by dynamic vulcanization of a fluorocarbon elastomer in the presence of a thermoplastic component and functional filler. In this embodiment, a method is provided for making the rubber composition, comprising combining a curative agent, an elastomeric material, a functional filler and a thermoplastic material to form a mixture. The mixture is heated at a temperature and for a time sufficient to effect vulcanization or cure of the fluorocarbon elastomer in the presence of the functional filler and thermoplastic material. Mechanical energy is applied to the mixture of elastomeric material, curative agent, functional filler and thermoplastic material during the heating step. Thus the method of the invention provides for mixing the elastomer, functional filler, and thermoplastic components in the presence of a curative agent and heating during the mixing to effect cure of the elastomeric component. Alternatively, the elastomeric material and thermoplastic material may be mixed for a time and at a shear rate sufficient to form a dispersion of the elastomeric material in a continuous or co-continuous thermoplastic phase. Thereafter, a functional filler and curative agent may be added to the dispersion of elastomeric material and thermoplastic material while continuing the mixing. Finally, the dispersion is heated while continuing to mix to produce the processable rubber composition of the invention.

The compositions of the invention are readily processable by conventional plastic processing techniques. In another embodiment, shaped articles are provided comprising the cured, fluorocarbon elastomers, and functional filler dispersed in a thermoplastic matrix. Shaped articles of the invention include, without limitation, seals, O-rings, gaskets, and hoses.

In a preferred embodiment, shaped articles with functional fillers prepared from the compositions of the invention exhibit an advantageous set of physical properties that includes a high degree of resistance to the effects of chemical solvents. In these embodiments, it is possible to provide articles for which the hardness, tensile strength, and/or the elongation at break change very little or change significantly less than comparable cured fluorocarbon elastomers or other known thermoplastic vulcanizates, when the articles are exposed for extended periods of time such as by immersion or partial immersion in organic solvents or fuels.

The fluorocarbon elastomer undergoes dynamic vulcanization in the presence of thermoplastic non-curing polymers to provide compositions with desirable rubber-like properties, but that can be thermally processed by conventional thermoplastic methods such as extrusion, blow molding, and injection molding. The elastomers are generally synthetic, non-crystalline polymers that exhibit rubber-like properties when crosslinked, cured, or vulcanized. As such, the cured elastomers, as well as the compositions of the invention made by dynamic vulcanization of the elastomers, are observed to substantially recover their original shape after removal of a deforming force, and show reversible elasticity up to high strain levels.

The vulcanized elastomeric material, also referred to herein generically as a “rubber”, is generally present as small particles within a continuous thermoplastic polymer matrix. A co-continuous morphology is also possible depending on the amount of elastomeric material relative to thermoplastic material, the functional filler, the cure system, and the mechanism and degree of cure of the elastomer and the amount and degree of mixing. Preferably, the elastomeric material is fully crosslinked/cured.

Full crosslinking can be achieved by adding an appropriate curative or curative system to a blend of thermoplastic material and elastomeric material, and vulcanizing or curing the rubber to the desired degree under vulcanizing conditions. In a preferred embodiment, the elastomer is crosslinked by the process of dynamic vulcanization. The term dynamic vulcanization refers to a vulcanization or curing process for a rubber (here a fluorocarbon elastomer) contained in a thermoplastic composition, wherein the curable rubber is vulcanized under conditions of sufficiently high shear at a temperature above the melting point of the thermoplastic component. The rubber is thus simultaneously crosslinked and dispersed within the thermoplastic matrix. Dynamic vulcanization is effected by applying mechanical energy to mix the elastomeric and thermoplastic components at elevated temperature in the presence of a curative in conventional mixing equipment such as roll mills, Moriyama mixers, Banbury mixers, Brabender mixers, continuous mixers, mixing extruders such as single and twin-screw extruders, and the like. An advantageous characteristic of dynamically cured compositions is that, notwithstanding the fact that the elastomeric component is fully cured, the compositions can be processed and reprocessed by conventional plastic processing techniques such as extrusion, injection molding and compression molding. Scrap or flashing can be salvaged and reprocessed.

Heating and mixing or mastication at vulcanization temperatures are generally adequate to complete the vulcanization reaction in a few minutes or less, but if shorter vulcanization times are desired, higher temperatures and/or higher shear may be used. A suitable range of vulcanization temperature is from about the melting temperature of the thermoplastic material (typically 120° C.) to about 300° C. or more. Typically, the range is from about 150° C. to about 250° C. A preferred range of vulcanization temperatures is from about 180° C. to about 220° C. It is preferred that mixing continue without interruption until vulcanization occurs or is complete.

If appreciable curing is allowed after mixing has stopped, an unprocessable thermoplastic vulcanizate may be obtained. In this case, a kind of post curing step may be carried out to complete the curing process. In some embodiments, the post curing takes the form of continuing to mix the elastomer and thermoplastic during a cool-down period.

After dynamic vulcanization, a homogeneous mixture is obtained, wherein the rubber is in the form of small dispersed particles essentially of an average particle size smaller than about 50 μm, preferably of an average particle size smaller than about 25 μm. More typically and preferably, the particles have an average size of about 10 μm or less, preferably about 5 μm or less, and more preferably about 1 μm or less. In other embodiments, even when the average particle size is larger, there will be a significant number of cured elastomer particles less than 1 μm in size dispersed in the thermoplastic matrix.

The size of the particles referred to above may be equated to the diameter of spherical particles, or to the diameter of a sphere of equivalent volume. It is to be understood that not all particles will be spherical. Some particles will be fairly isotropic so that a size approximating a sphere diameter may be readily determined. Other particles may be anisotropic in that one or two dimensions may be longer than another dimension. In such cases, the preferred particle sizes referred to above correspond to the shortest of the dimensions of the particles.

In some embodiments, the cured elastomeric material is in the form of particles forming a dispersed, discrete, or non-continuous phase wherein the particles are separated from one another by the continuous phase made up of the thermoplastic matrix. Such structures are expected to be more favored at relatively lower loadings of cured elastomer, i.e. where the thermoplastic material takes up a relatively higher volume of the compositions. In other embodiments, the cured material may be in the form of a co-continuous phase with the thermoplastic material. Such structures are believed to be favored at relatively higher volume of the cured elastomer. At intermediate elastomer loadings, the structure of the two-phase compositions may take on an intermediate state in that some of the cured elastomer may be in the form of discrete particles and some may be in the form of a co-continuous phase.

The homogenous nature of the compositions, the small particle size indicative of a large surface area of contact between the phases, and the ability of the compositions to be formed into shaped articles having sufficient hardness, tensile strength, modulus, elongation at break, or compression set to be useful in industrial applications, indicate a relatively high degree of compatibility between the elastomer and thermoplastic phases. It is believed such compatibility results from the dynamic vulcanization process and inclusion of functional filler. During the process, the elastomeric particles are being crosslinked or cured while the two phases are being actively mixed and combined. In addition, the higher temperature and the presence of reactive crosslinking agent may lead to some physical or covalent linkages between the two phases. At the same time, the process leads to a finer dispersion of the discrete or co-continuous elastomer phase in the thermoplastic than is possible with simple filling.

The progress of the vulcanization may be followed by monitoring mixing torque or mixing energy requirements during mixing. The mixing torque or mixing energy curve generally goes through a maximum after which mixing can be continued somewhat longer to improve the fabricability of the blend. If desired, one can add additional ingredients, such as the stabilizer package, after the dynamic vulcanization is complete. The stabilizer package is preferably added to the thermoplastic vulcanizate after vulcanization has been essentially completed, i.e., the curative has been essentially consumed.

The processable rubber compositions of the present invention may be manufactured in a batch process or a continuous process.

In a batch process, predetermined charges of elastomeric material, thermoplastic material, functional filler and curative agents, or curative package, are added to a mixing apparatus. In a typical batch procedure, the elastomeric material and thermoplastic material are first mixed, blended, masticated or otherwise physically combined until a desired particle size of elastomeric material is provided in a continuous phase of thermoplastic material. When the structure of the elastomeric material is as desired, a functional filler and curative agent may be added while continuing to apply mechanical energy to mix the elastomeric material and thermoplastic material. Curing is effected by heating or continuing to heat the mixing combination of thermoplastic and elastomeric material in the presence of the curative agent. When cure is complete, the processable rubber composition may be removed from the reaction vessel (mixing chamber) for further processing.

It is preferred to mix the elastomeric material and thermoplastic material at a temperature where the thermoplastic material softens and flows. If such a temperature is below that at which the curative agent is activated, the curative agent may be a part of the mixture during the initial particle dispersion step of the batch process. In some embodiments, a curative is combined with the elastomeric and polymeric material at a temperature below the curing temperature. When the desired dispersion is achieved, the functional filler can be added and the temperature may be increased to effect cure. In one embodiment, commercially available elastomeric materials are used that contain a curative pre-formulated into the elastomer. However, if the curative agent is activated at the temperature of initial mixing, it is preferred to leave out the curative until the desired particle size distribution of the elastomeric material in the thermoplastic matrix is achieved. In another embodiment, curative is added after the elastomeric and thermoplastic material are mixed. In a preferred embodiment, the curative agent is added to a mixture of elastomeric particles in thermoplastic material while the entire mixture continues to be mechanically stirred, agitated or otherwise mixed. Further, it is preferred to add any fibrous functional filler as late in the process as feasible, thus minimizing and avoiding unnecessary breakage of fiber filler during the mixing action.

Continuous processes may also be used to prepare the functional filler containing processable rubber compositions of the invention. In a preferred embodiment, a twin screw extruder apparatus, either co-rotation or counter-rotation screw type, is provided with ports for material addition and reaction chambers made up of modular components of the twin screw apparatus. In a typical continuous procedure, thermoplastic material and elastomeric material are combined by inserting them into the screw extruder together from a first hopper using a feeder (loss-in-weight or volumetric feeder). Temperature and screw parameters may be adjusted to provide a proper temperature and shear to effect the desired mixing and particle size distribution of an uncured elastomeric component in a thermoplastic material matrix. The duration of mixing may be controlled by providing a longer or shorter length of extrusion apparatus or by controlling the speed of screw rotation for the mixture of elastomeric material and thermoplastic material to go through during the mixing phase. The degree of mixing may also be controlled by the mixing screw element configuration in the screw shaft, such as intensive, medium or mild screw designs. Then, at a downstream port, by using side feeder (loss-in-weight or volumetric feeder), the functional filler and curative agent, or curative package, may be added continuously to the mixture of thermoplastic material and elastomeric material as it continues to travel down the twin screw extrusion pathway. Downstream of the curative additive port, the mixing parameters and transit time may be varied as described above. The addition of fillers, especially fiber fillers, is preferred at the downstream feeding section to minimize the breakage of fibers during the high shearing mixing action of the twin-screw extrusion. By adjusting the shear rate, temperature, duration of mixing, mixing screw element configuration, as well as the time of adding the curative agent, or curative package, processable rubber compositions of the invention may be made in a continuous process. As in the batch process, the elastomeric material may be commercially formulated to contain a curative agent, generally a phenol or phenol resin curative.

The compositions and articles of the invention will contain a sufficient amount of vulcanized elastomeric material (“rubber”) to form a rubbery composition of matter, that is, they will exhibit a desirable combination of flexibility, softness, and compression set. Preferably, the compositions should comprise at least about 25 parts by weight rubber, preferably at least about 35 parts by weight rubber, more preferably at least about 40 parts by weight rubber, even more preferably at least about 45 parts by weight rubber, and still more preferably at least about 50 parts by weight rubber per 100 parts by weight of the rubber and thermoplastic polymer combined. The amount of cured rubber within the thermoplastic vulcanizate is generally from about 5 to about 95 percent by weight, preferably from about 35 to about 95 percent by weight, more preferably from about 40 to about 90 weight percent, and more preferably from about 50 to about 80 percent by weight of the total weight of the rubber and the thermoplastic polymer combined.

The amount of thermoplastic polymer within the processable rubber compositions of the invention is generally from about 5 to about 95 percent by weight, preferably from about 10 to about 65 percent by weight and more preferably from about 20 to about 50 percent by weight of the total weight of the rubber and the thermoplastic combined.

As noted above, the processable rubber compositions and shaped articles of the invention include a cured rubber, a functional filler and a thermoplastic polymer. Preferably, the thermoplastic vulcanizate is a homogeneous mixture wherein the rubber is in the form of finely-divided and well-dispersed rubber particles within a non-vulcanized matrix. It should be understood, however, that the thermoplastic vulcanizates of the this invention are not limited to those containing discrete phases inasmuch as the compositions of this invention may also include other morphologies such as co-continuous morphologies. In especially preferred embodiments, the rubber particles have an average particle size smaller than about 50 μm, more preferably smaller than about 25 μm, even more preferably smaller than about 10 μm or less, and still more preferably smaller than about 5 μm.

Advantageously, the shaped articles of the invention are rubber-like materials that, unlike conventional rubbers, can be processed and recycled like thermoplastic materials. These materials are rubber like to the extent that they will retract to less than 1.5 times their original length within one minute after being stretched at room temperature to twice its original length and held for one minute before release, as defined in ASTM D1566. Also, these materials satisfy the tensile set requirements set forth in ASTM D412, and they also satisfy the elastic requirements for compression set per ASTM D395.

The reprocessability of the rubber compositions of the invention may be exploited to provide a method for reducing the costs of a manufacturing process for making shaped rubber articles. The method involves recycling scrap generated during the manufacturing process to make other new shaped articles. Because the compositions of the invention and the shaped articles made from the compositions are thermally processable, scrap may readily be recycled for re-use by collecting the scrap, optionally cutting, shredding, grinding, milling, otherwise comminuting the scrap material, and re-processing the material by conventional thermoplastic techniques. Techniques for forming shaped articles from the recovered scrap material are in general the same as those used to form the shaped articles—the conventional thermoplastic techniques include, without limitation, blow molding, injection molding, compression molding, and extrusion.

The re-use of the scrap material reduces the costs of the manufacturing process by reducing the material cost of the method. Scrap may be generated in a variety of ways during a manufacturing process for making shaped rubber articles. For example, off-spec materials may be produced. Even when on-spec materials are produced, manufacturing processes for shaped rubber articles tend to produce waste, either through inadvertence or through process design, such as the material in sprues of injection molded parts. The re-use of such materials through recycling reduces the material and thus the overall costs of the manufacturing process.

For thermoset rubbers, such off spec materials usually can not be recycled into making more shaped articles, because the material can not be readily re-processed by the same techniques as were used to form the shaped articles in the first place. Recycling efforts in the case of thermoset rubbers are usually limited to grinding up the scrap and the using the grinds as raw material in a number products other than those produced by thermoplastic processing technique

The present invention is further illustrated through the following non-limiting examples.

### EXAMPLES

In Examples 1-10, the following materials are used:

Dyneon FE 5840 is a terpolymer elastomer of VDF/HFP/TFE, from Dyneon (3M).

Dyneon BRE 7231X is a base resistant elastomer, based on a terpolymer of TFE, propylene, and VDF, commercially available from Dyneon (3M).

Hylar MP-10 is a high performance melt-processable polyvinylidene fluoride homopolymer.

Rhenofit CF is a calcium hydroxide crosslinker for fluoroelastomers, from Rhein Chemie MT Black is a carbon black filler.

Elastomag 170 is a high activity powdered magnesium oxide from Rohm and Haas.

Struktol WS-280 is a silane coupling agent from Struktol.

Nyad 400 and 10222 contain Wollastonite, a naturally occurring calcium metasilicate (CaSiO₃).

Tecnoflon FPA-1 is a functionalized perfluoropolyether from Ausimont.

Kevlar is a polyamide from by E.I. du Pont de Nemours and Company.

Austin Black is carbon black.

MT N-999 is carbon black.

Kynar Flex 2504 is a polyvinylidene fluoride resin available from ATOFINA Chemicals, Inc.

Luperco XL 100 is a peroxide from Pennwalt Corporation.

TAIC is a symmetric polyfunctions triazine compound.

Examples 1-10 demonstrate dynamic vulcanization of copolymers of tetrafluoroethylene and propylene in the presence of a variety of thermoplastic elastomers and semicrystalline thermoplastic materials. The Dyneon and Tecnoflon materials are used at a level of 100 parts, and the thermoplastic materials are used at levels between 25 parts per hundred Dyneon or Tecnoflon to 125 parts per hundred parts of the Dyneon or Tecnoflon material.

To demonstrate a batch process, the ingredients are mixed in a Brabender mixer according to the following procedure. The thermoplastic material is melted in a Brabender mixer and stirred. To the molten stirring thermoplastic material is added the Dyneon or Tecnoflon, along with the carbon black. Mixing continues at the melting point of the thermoplastic material for a further 10-20 minutes, preferably at a temperature of about 120-180° C. Then, the curing accelerators are added and the mixing and heating continued for a further 10 minutes. The vulcanized material is cooled down and removed from the Brabender mixer. Shaped articles may be prepared from the vulcanized composition by conventional compression molding, injection molding, extrusion, and the like. Plaques may be fabricated from the vulcanized composition for measurement of physical properties.

| | Example 1a | | Example 1b | | | | | | | |
|---|---|---|---|---|---|---|---|---|---|---|
| Ingredient | pphr | g | pphr | g | | | | | | |
| Dyneon FE5840 | 70.0 | 185.3 | 70.0 | 185.3 | | | | | | |
| Dyneon BRE 7231X | 30.0 | 79.4 | 30.0 | 79.4 | | | | | | |
| Hylar MP-10 | 25.0 | 66.2 | 25.0 | 66.2 | | | | | | |
| Rhenofit CF | 6.0 | 15.9 | 6.0 | 15.9 | | | | | | |
| Elastomag 170 | 3.0 | 7.9 | 3.0 | 7.9 | | | | | | |
| Struktol WS-280 | 1.0 | 2.6 | 1.0 | 2.6 | | | | | | |
| Nyad 400 | 10.00 | 26.5 | | | | | | | | |
| Tecnoflon FPA-1 | 1.0 | 2.6 | 1.0 | 2.6 | | | | | | |
| Nyad 10222 | | | 10.00 | 26.5 | | | | | | |
| | Example 2a | | Example 2b | | Example 2c | | | | | |
| Ingredient | pphr | g | pphr | G | pphr | g | | | | |
| Dyneon FE5840 | 70.0 | 185.3 | 70.0 | 185.3 | 70.0. | 185.3 | | | | |
| Dyneon BRE 7231X | 30.0 | 79.4 | 30.0 | 79.4 | 30.0 | 79.4 | | | | |
| Hylar MP-10 | 25.0 | 66.2 | 25.0 | 66.2 | 25.0 | 66.2 | | | | |
| Rhenofit CF | 6.0 | 15.9 | 6.0 | 15.9 | 6.0 | 15.9 | | | | |
| Elastomag 170 | 3.0 | 7.9 | 3.0 | 7.9 | 3.0 | 7.9 | | | | |
| Struktol WS-280 | 1.0 | 2.6 | 1.0 | 2.6 | 1.0 | 2.6 | | | | |
| Tecnoflon FPA-1 | 1.00 | 2.6 | 1.00 | 2.6 | 1.00 | 2.6 | | | | |
| Kevlar 29 or 49 Fiber | 10.00 | 26.5 | | | | | | | | |
| Kevlar w/plasma treated | | | 10.00 | 26.5 | | | | | | |
| Kevlar w/Silane coated | | | | | 10.00 | 26.5 | | | | |
| | Example 3a | | Example 3b | | Example 3c | | Example 3d | | | |
| Ingredient | pphr | g | pphr | G | pphr | G | pphr | g | | |
| Dyneon FE5840 | 70.0 | 185.3 | 70.0 | 185.3 | 70.0 | 185.3 | 70.0 | 185.3 | | |
| Dyneon BRE 7231X | 30.0 | 79.4 | 30.0 | 79.4 | 30.0 | 79.4 | 30.0 | 79.4 | | |
| Hylar MP-10 | 25.0 | 66.2 | 25.0 | 66.2 | 25.0 | 66.2 | 25.0 | 66.2 | | |
| Rhenofit CF | 6.0 | 15.9 | 6.0 | 15.9 | 6.0 | 15.9 | 6.0 | 15.9 | | |
| Elastomag 170 | 3.0 | 7.9 | 3.0 | 7.9 | 3.0 | 7.9 | 3.0 | 7.9 | | |
| Struktol WS-280 | 1.0 | 2.6 | 1.0 | 2.6 | 1.0 | 2.6 | 1.0 | 2.6 | | |
| Nyad 400 | 10.00 | 26.5 | | | 5.00 | 13.2 | | | | |
| Tecnoflon FPA-1 | 1.00 | 2.6 | 1.00 | 2.6 | 1.00 | 2.6 | 1.00 | 2.6 | | |
| Nyad 10222 | | | 10.00 | 26.5 | | | 5.00 | 13.2 | | |
| Austin Black | | | | | 5.00 | 13.2 | 5.00 | 13.2 | | |
| | Example 4a | | Example 4b | | Example 4c | | | | | |
| Ingredient | pphr | g | pphr | g | Pphr | g | | | | |
| Tecnoflon FOR 80HS | 100.0 | 255.9 | 100.0 | 266.5 | 100.0 | 266.5 | | | | |
| Solvay Hylar MP-10 | 25.0 | 64.0 | 25.0 | 66.6 | 25.0 | 66.6 | | | | |
| Elastomag 170 (MgO) | 9.0 | 23.0 | 3.0 | 8.0 | 3.0 | 8.0 | | | | |
| MT Black (N990) | 10.00 | 25.6 | 10.00 | 26.7 | 10.00 | 26.7 | | | | |
| Struktol WS-280 | 1.00 | 2.6 | 1.00 | 2.7 | 1.00 | 2.7 | | | | |
| Tecnoflon FPA-1 | 1.0 | 2.6 | 1.00 | 2.7 | 1.00 | 2.7 | | | | |
| Kevlar 29 or 49 fiber | 5.00 | 12.8 | | | | | | | | |
| Kevlar w/plasma treated | | | 5.00 | 13.3 | | | | | | |
| Kevlar w/Silane coated | | | | | 5.00 | 13.3 | | | | |
| | Example 5a | | Example 5b | | Example 5c | | | | | |
| Ingredient | pphr | g | pphr | g | pphr | g | | | | |
| Tecnoflon P757 | 100.0 | 254.3 | 100.0 | 215.6 | 100.0 | 196.2 | | | | |
| Kynar Flex 2504 | 25.0 | 63.6 | 25.0 | 53.9 | 25.0 | 49.1 | | | | |
| Luperco 101 XL | 3.0 | 7.6 | 3.0 | 6.5 | 3.0 | 5.9 | | | | |
| TAIC, 75% Dispersion | 4.00 | 10.2 | 4.00 | 8.6 | 4.00 | 7.8 | | | | |
| ZnO | 5.00 | 12.7 | 5.00 | 10.8 | 5.00 | 9.8 | | | | |
| MT N-990 Carbon Black | 10.00 | 25.4 | 10.00 | 21.6 | 10.00 | 19.6 | | | | |
| Kevlar 29 or 49 fiber | 5.0 | 12.7 | | | | | | | | |
| Kevlar w/plasma treated | | | 5.00 | 10.8 | | | | | | |
| Kevlar w/Silane coated | | | | | 5.00 | 9.8 | | | | |
| | Example 6a | | Example 6b | | Example 6c | | Example 6d | | | |
| Ingredient | pphr | g | pphr | g | pphr | g | pphr | g | | |
| Tecnoflon FOR 80HS | 100.0 | 264.7 | 100.0 | 234.2 | 100.0 | 179.8 | 100.0 | 145.8 | | |
| Solvay Hylar MP-10 | 25.0 | 66.2 | 50.0 | 117.1 | 100.0 | 179.8 | 150.0 | 218.8 | | |
| Elastomag 170 (MgO) | 9.0 | 23.8 | 3.0 | 7.0 | 3.0 | 5.4 | 3.0 | 4.4 | | |
| MT Black (N990) | | | | | 5.00 | 9.0 | 5.00 | 7.3 | | |
| Struktol WS-280 | 1.00 | 2.6 | 1.00 | 2.3 | 1.00 | 1.8 | 1.00 | 1.5 | | |
| Tecnoflon FPA-1 | 1.00 | 2.6 | 1.00 | 2.3 | 1.00 | 1.8 | 1.00 | 1.5 | | |
| Nyad 400 | 10.00 | 26.5 | | | 5.00 | 9.0 | | | | |
| Nyad 10222 | | | 10.00 | 23.4 | | | 5.00 | 7.3 | | |
| | Example 7a | | Example 7b | | Example 7c | | Example 7d | | | |
| Ingredient | pphr | g | pphr | g | pphr | g | pphr | G | | |
| Tecnoflon P757 | 100.0 | 262.9 | 100.0 | 190.5 | 100.0 | 134.3 | 100.0 | 103.5 | | |
| Kynar Flex 2504 | 25.0 | 65.7 | 50.0 | 95.2 | 100.0 | 134.3 | 150.0 | 155.2 | | |
| Luperco 101 XL | 3.0 | 7.9 | 3.0 | 5.7 | 3.0 | 4.0 | 3.0 | 3.1 | | |
| TAIC, 75% Dispersion | 4.00 | 10.5 | 4.00 | 7.6 | 4.00 | 5.4 | 4.00 | 4.1 | | |
| ZnO | 5.00 | 13.1 | 5.00 | 9.5 | 5.00 | 6.7 | 5.00 | 5.2 | | |
| MT N-990 Carbon Black | | | | | 5.00 | 6.7 | 5.00 | 5.2 | | |
| Nyad 400 | 10.00 | 26.3 | | | 5.00 | 6.7 | | | | |
| Nyad 10222 | | | 10.00 | 19.0 | | | 5.00 | 5.2 | | |
| | Example 8a | | Example 8b | | Example 8c | | | | | |
| Ingredient | pphr | g | pphr | g | pphr | g | | | | |
| Dyneon FE5840 | 70.0 | 179.2 | 70.0 | 179.2 | 70.0 | 179.2 | | | | |
| Dyneon BRE 7231X | 30.0 | 76.8 | 30.0 | 76.8 | 30.0 | 76.8 | | | | |
| Hylar MP-10 | 25.0 | 64.0 | 25.0 | 64.0 | 25.0 | 64.0 | | | | |
| Rhenofit CF | 6.0 | 15.4 | 6.0 | 15.4 | 6.0 | 15.4 | | | | |
| Elastomag 170 | 3.0 | 7.7 | 3.0 | 7.7 | 3.0 | 7.7 | | | | |
| Struktol WS-280 | 1.0 | 2.6 | 1.0 | 2.6 | 1.0 | 2.6 | | | | |
| Tecnoflon FPA-1 | 1.00 | 2.6 | 1.00 | 2.6 | 1.00 | 2.6 | | | | |
| Kevlar 29 or 49 fiber | 5.00 | 12.8 | | | | | | | | |
| Kevlar w/plasma treated | | | 5.00 | 12.8 | | | | | | |
| Kevlar w/Silane coated | | | | | 5.00 | 12.8 | | | | |
| Austin Black | 10.00 | 25.6 | 10.00 | 25.6 | 10.00 | 25.6 | | | | |
| | Example 9a | | Example 9b | | Example 9c | | Example 9d | | Example 9e | |
| Ingredient | pphr | g | pphr | g | pphr | g | pphr | g | pphr | g |
| Dyneon FE5840 | 70.0 | 2594.1 | 70.0 | 2281.5 | 70.0 | 2784.8 | 70.0 | 2427.8 | 70.0 | 2427.8 |
| Dyneon BRE 7231X | 30.0 | 1111.8 | 30.0 | 977.8 | 30.0 | 1193.5 | 30.0 | 1040.5 | 30.0 | 1040.5 |
| Ausimont Hylar MP-10 | 25.0 | 926.5 | 25.0 | 814.8 | 25.0 | 994.6 | 25.0 | 867.1 | | |
| Rhenofit CF | 6.0 | 222.4 | 6.0 | 195.6 | 6.0 | 238.7 | 6.0 | 208.1 | 6.0 | 208.1 |
| Elastomag 170 | 3.0 | 111.2 | 3.0 | 97.8 | 3.0 | 119.3 | 3.0 | 104.0 | 3.0 | 104.0 |
| Struktol WS-280 | 1.0 | 37.1 | 1.0 | 32.6 | 1.0 | 39.8 | 1.0 | 34.7 | 1.0 | 34.7 |
| Austin Black | 10.00 | 370.6 | 10.00 | 325.9 | | | | | | |
| Tecnoflon FPA-1 | 1.00 | 37.1 | 1.00 | 32.6 | 1.00 | 39.8 | 1.00 | 34.7 | 1.00 | 34.7 |
| Graphite 4467 | | | 5.00 | 163.0 | | | 5.00 | 173.4 | 5.00 | 173.4 |
| Nyad 400 | | | 10.00 | 325.9 | | | 10.00 | 346.8 | 10.00 | 346.8 |
| 400 Wollastocoat 10222 | | | 5.00 | 163.0 | | | 5.00 | 173.4 | 5.00 | 173.4 |
| Ausimont Halar 500LC | | | | | | | | | 25.00 | 867.1 |

| | Example 10a | | Example 10b | | Example 10c | | Example 10d | |
|---|---|---|---|---|---|---|---|---|
| Ingredient | pphr | g | pphr | g | pphr | g | pphr | g |
| Dyneon FE5840 | 70.0 | 179.2 | 70.0 | 179.2 | 70.0 | 179.2 | 70.0 | 179.2 |
| Dyneon BRE 7231X | 30.0 | 76.8 | 30.0 | 76.8 | 30.0 | 76.8 | 30.0 | 76.8 |
| Ausimont Hylar MP-10 | 25.0 | 64.0 | 25.0 | 64.0 | 25.0 | 64.0 | 25.0 | 64.0 |
| Rhenofit CF | 6.0 | 15.4 | 6.0 | 15.4 | 6.0 | 15.4 | 6.0 | 15.4 |
| Elastomag 170 | 3.0 | 7.7 | 3.0 | 7.7 | 3.0 | 7.7 | 3.0 | 7.7 |
| Struktol WS-280 | 1.0 | 2.6 | 1.0 | 2.6 | 1.0 | 2.6 | 1.0 | 2.6 |
| Tecnoflon FPA-1 | 1.00 | 2.6 | 1.00 | 2.6 | 1.00 | 2.6 | 1.00 | 2.6 |
| Carbon fiber w/o coating | 5.00 | 12.8 | | | | | | |
| Carbon fiber with coating | | | 5.00 | 12.8 | | | | |
| Glass fiber w/o coating | | | | | 5.00 | 12.8 | | |
| Glass fiber with coating | | | | | | | 5.0 | 12.8 |
| Austin black | 10.00 | 25.6 | 10.00 | 25.6 | 10.00 | 25.6 | 10.00 | 25.6 |

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. A method for making a rubber composition comprising:
(a) forming a mixture of a fluorocarbon elastomer with a thermoplastic material;
(b) adding a functional filler to the mixture; and
(c) dynamically vulcanizing the mixture.

2. A method according to claim 1, wherein the functional filler is selected from the group consisting of reinforcing fillers, lubricating fillers, thermally conductive fillers, electrically conductive fillers, physical extender fillers, and mixtures thereof.

3. A method according to claim 2, wherein the functional filler comprises a powder having a particle size of between about 0.01 to about 1,000 μm.

4. A method according to claim 3, wherein the functional filler comprises a powder having a particle size of between about 0.1 to about 100 μm.

5. A method according to claim 2, wherein the functional filler comprises a high tensile strength aromatic polyamide fiber.

6. A method according to claim 2, wherein the functional filler is plasma treated or silane coated.

7. A method according to claim 2, wherein the functional filler comprises carbon fiber.

8. A method according to claim 2, wherein the functional filler comprises glass fiber.

9. A method according to claim 1, further comprising adding a curative package to the mixture prior to vulcanization.

10. A method according to claim 9, comprising heating and mixing the fluorocarbon elastomer and thermoplastic mixture to a homogeneous molten blend prior to adding the functional filler and curative package.

11. A method according to claim 1, comprising heating the mixture to a temperature above the melting point of the thermoplastic material.

12. A method according to claim 11, wherein the temperature is from about 220° C. to about 250° C.

13. A method according to claim 1, wherein the thermoplastic material comprises a fluorine-containing thermoplastic material.

14. A method according to claim 1, wherein the mixture comprises from about 5 to about 50% by weight functional filler material based on the total weight of the vulcanized elastomeric material, thermoplastic material and functional filler material combined.

15. A method according to claim 14, wherein the mixture comprises from about 20 to about 30% by weight functional filler material based on the total weight of the vulcanized elastomeric material, thermoplastic material and functional filler material combined.

16. A method according to claim 1, wherein the combination comprises at least about 25% by weight functional filler material based on the total weight of the vulcanized elastomeric material, thermoplastic material and functional filler material combined.

17. A method according to claim 1, comprising a batch process.

18. A method according to claim 1, comprising a continuous process.

19. A method according to claim 1, carried out in a twin screw extruder.

20. A method according to claim 9, wherein the curative package comprises a peroxide.

21. A method according to claim 9, wherein the curative package comprises a bisphenol.

22. A method according to claim 9, wherein the curative package contains a diamine.

23. A method according to claim 9, wherein the curative package further comprises at least one processing aid.

24. A method according to claim 1, comprising mixing the elastomeric material and the thermoplastic material for a time and at a shear rate sufficient to form a dispersion of the elastomeric material in a continuous thermoplastic phase.

25. A shaped article comprising a cured fluorocarbon elastomer and functional filler dispersed in a continuous phase matrix comprising a thermoplastic material.

26. A shaped article according to claim 25, wherein the functional filler is selected from the group consisting of a reinforcing filler, a lubricating filler, a thermally conductive filler, an electrically conductive filler, a physical extender filler, and mixtures thereof.

27. A shaped article according to claim 26, wherein the functional filler comprises a high strength aromatic polyamide fiber.

28. A shaped article according to claim 26, wherein the functional filler comprises carbon fiber.

29. A shaped article according to claim 26, wherein the functional filler comprises glass fiber.

30. A shaped article according to claim 26, wherein the functional filler is chemically treated or coated.

31. A shaped article according to claim 25, wherein the cured fluorocarbon elastomer is present at a level of at least 35% by weight based on the total weight of cured elastomer and thermoplastic polymer.

32. A shaped article according to claim 31, wherein the cured fluorocarbon elastomer is present at a level of at least 50% by weight based on the total weight of cured fluorocarbon elastomer and thermoplastic polymer.

33. A shaped article according to claim 25, comprising from about 5 to about 50% by weight functional filler material based on the total weight of cured fluorocarbon elastomer, thermoplastic material and functional filler material combined.

34. A shaped article according to claim 33, comprising from about 20 to about 30% by weight functional filler material based on the total weight of cured fluorocarbon elastomer, thermoplastic material and functional filler material combined.

35. A shaped article according to claim 25, wherein the hardness of the article is about Shore A 50 or greater, the tensile strength of the article is about 4 MPa or greater, the modulus at 100% of the article is about 2 Mpa or greater, or the elongation at break of the article is about 50% or greater.

36. A seal according to claim 25.

37. An O-ring according to claim 25.

38. A gasket according to claim 25.

39. A hose according to claim 25.

40. A shaped article according to claim 25, wherein the thermoplastic material comprises a fluorine-containing thermoplastic polymer.

41. A continuous process for making a processable rubber composition comprising:
(a) combining a fluorocarbon elastomer and a thermoplastic material,
(b) feeding the combination into a heated mixing apparatus,
(c) mixing the combination for a time and at a temperature sufficient to form a homogeneous molten blend,
(d) adding a functional filler,
(e) adding a curative package to effect a total or partial cure,
(f) heating, mixing and dynamically vulcanizing the mixture, and
(g) extruding a cured mixture.

42. A process according to claim 41, wherein the functional filler is selected from the group consisting of a reinforcing filler, a lubricating filler, a thermally conductive filler, an electrically conductive filler, a physical extender filler, and mixtures thereof.

43. A process according to claim 42, wherein the functional filler comprises a fibrous high temperature aromatic polyamides containing repeating units derived from diamines and aromatic diacids such as terephthalic acid.

44. A process according to claim 42, wherein the functional filler has an average aspect ratio of about 5:50.

45. A process according to claim 42, wherein the functional filler is in powder form with a particle size of about 0.01 to 1,000 μm.

46. A process according to claim 41, comprising extruding the cured mixture through a strand die.

47. A process according to claim 46, further comprising quenching and pelletizing the extruded mixture.

48. A process according to claim 41 using a mixing apparatus having a first feeder and a second feeder downstream from the first feeder, comprising:
(i) injecting the fluorocarbon elastomer and thermoplastic material into the first feeder, and
(ii) injecting the functional filler and curative package into the second feeder.

49. A process according to claim 41, wherein the fluorocarbon elastomer and a thermoplastic material are combined together in a pre-mixture.

50. A process according to claim 41, comprising a residence time of about 5 to 10 minutes with a screw speed of between about 100 to 200 rpm and a barrel temperature from about 220° C. and about 250° C.

51. A process according to claim 41, wherein the curative package comprises a peroxide.

52. A process according to claim 41, wherein the curative package comprises a bisphenol.

53. A process according to claim 41, wherein the curative package comprises a diamine.

54. A process according to claim 41, wherein the curative package further comprises at least one processing aid.

55. A processable rubber composition comprising cured fluorocarbon elastomer and functional filler dispersed in a thermoplastic matrix, wherein the cured fluorocarbon elastomer is present as a discrete phase or a phase co-continuous with the matrix.

56. A rubber composition according to claim 55, wherein the cured fluorocarbon elastomer and/or functional filler is present at least in part as particles dispersed in a continuous thermoplastic phase.

57. A rubber composition according to claim 55, wherein the cured fluorocarbon elastomer and/or functional filler is present at least in part in a dispersed phase co-continuous with the thermoplastic phase.

58. A rubber composition according to claim 55, wherein the functional filler is selected from the group consisting of a reinforcing filler, a lubricating filler, a thermally conductive filler, an electrically conductive filler, a physical extender filler, and mixtures thereof.

59. A rubber composition according to claim 55, wherein the functional filler is glass fiber.

60. A rubber composition according to claim 55, wherein the functional filler is carbon fiber.

61. A rubber composition according to claim 55, wherein the functional filler is chemically treated or coated.

62. A rubber composition according to claim 55, wherein the thermoplastic polymer comprises an amorphous polymer with a glass transition temperature greater than or equal to 150° C.

63. A thermoprocessable rubber composition made by a process comprising dynamically vulcanizing a fluorocarbon elastomer in the presence of a fluorine-containing thermoplastic material and functional filler.

64. A composition according to claim 63, wherein the functional filler is selected from the group consisting of a reinforcing filler, a lubricating filler, a thermally conductive filler, an electrically conductive filler, a physical extender filler, and mixtures thereof.

65. A composition according to claim 64, wherein the functional filler comprises a high tensile strength aromatic polyamide fiber.

66. A composition according to claim 64, wherein the functional filler comprises carbon fiber.

67. A composition according to claim 64, wherein the functional filler comprises glass fiber.

68. A composition according to claim 63, made by a process comprising:
(a) combining, mixing, and melting a fluorocarbon elastomer and non-fluorine containing thermoplastic material;
(b) adding the functional filler and curative agent; and
(c) vulcanizing the mixture.

69. A composition according to claim 68, made by a process comprising:
(i) mixing the elastomer material and thermoplastic material for a time and at a shear rate sufficient to form a dispersion of the elastomeric material in a continuous thermoplastic phase;
(ii) adding a curative and functional filler to the dispersion while continuing the mixing; and
(iii) heating the dispersion while continuing to mix the curative, elastomeric material, functional filler and thermoplastic material.

70. A seal-gasket product containing an elastomeric thermoplastic composition comprising a dual phase composition formed from a continuous first phase and a thermoset mixture second phase dispersed throughout the first phase wherein the thermoset mixture further comprises a functional filler.

71. A composition according to claim 70, wherein the functional filler is selected from the group consisting of a reinforcing filler, a lubricating filler, a thermally conductive filler, an electrically conductive filler, a physical extender filler, and mixtures thereof.

72. A method for making a rubber composition comprising:
forming a mixture of a fluorocarbon elastomer with a thermoplastic material;
adding high tensile strength aromatic polyamide fiber and curative package to the mixture; and
dynamically vulcanizing the mixture.
